(19) United States
(12) Patent Application Publication
(10) Pub. No.: US 2016/0198729 A1
(43) Pub. Date: Jul. 14, 2016

(54) CONTROL METHOD FOR MIXING CONTROLLED ATMOSPHERE STORAGE OF FRUIT VEGETABLES ON OCEANGOING SHIPS

(71) Applicants: Jiangnan University, Wuxi (CN); Wuxi Delin Marine Equipment Co. Ltd., Wuxi (CN)

(72) Inventors: Min Zhang, Wuxi (CN); Jiali Fan, Wuxi (CN); Feng Dai, Wuxi (CN); Yongliang Song, Wuxi (CN); Dongcui Fan, Wuxi (CN)

(73) Assignees: Jiangnan University, Wuxi (CN); Wuxi Delin Marine Equipment Co. Ltd., Wuxi (CN)

(21) Appl. No.: 14/809,233

(22) Filed: Jul. 26, 2015

(30) Foreign Application Priority Data
Jan. 14, 2015 (CN) 2015 100 168 95.2

(51) Int. Cl. A23B 7/152; A23B 7/04

(52) U.S. Cl. CPC A23B 7/152; A23B 7/04; A23V 2002/00

(57) ABSTRACT

The invention achieves control over mixing controlled atmosphere storage of fruit vegetables by preparing an air-conditioned cold store, selecting fruits and vegetables, precooling, and stacking. Fruits and vegetables, upon pickup. are precooled to 9-11° C. in a vacuum pre-cooler for 12-24 hours. They are then stacked in a controlled atmosphere storage house. O₂, CO₂, N₂ and Ar with different proportions are used for modified atmosphere packaging. The invention can extend the storage of mixing storage of various kinds of typical fruits and vegetables to more than 50 days, during which the fruits and vegetables are maintained in good color and flavor and have higher peroxidase, superoxide dismutase, catalase and cellulose activity; also, accumulation of hazardous substances such as superoxide anion free radical, hydrogen peroxide and malonaldehyde is effectively reduced, the retention rate of Vc is up to 80%-90%, and the weight loss ratio can be controlled to be below 8%.

### CROSS REFERENCE TO RELATED APPLICATION

The present application claims priority to Chinese Patent Application CN 2015 100 168 95.2 filed on Jan. 14, 2015.

### BACKGROUND

1. Technical Field

The present invention relates to a fruit and vegetable fresh-keeping method, and particularly to a control method for mixing controlled atmosphere storage of fruit vegetables on oceangoing ships, which belongs to the field of fruit and vegetable fresh-keeping technologies.

2. Related Art

Fruit vegetables use fruit and young big seeds as edible vegetables, which, according to different fruit structures or branches of botany, can be divided into three types, i.e., solanaceous vegetables, melon vegetables and legume vegetables. Because most fruit vegetables grow in high-temperature seasons, the fruit vegetables are not suitable for low-temperature storage (e.g., 0° C.), and are generally difficult to store. Respiration climacteric vegetables mean that, during the process of growth and ripeness of vegetables, respiration intensity suddenly rises and drops rapidly after reaching a peak value. Some typical fruit vegetables are introduced briefly as follows.

Green peppers, Latin name Capsicum annuum L, alias chilies, bellpeppers, bell peppers, etc., dicotyledoneae, Asteridae, Solanaceae. The green peppers are nutritious, rich in vitamin C, and quite popular to the customers. The green peppers are respiration climacteric vegetables.

Tomatoes, Latin name Solanum lycopersicum L., Solanum, Solanales, Solanaceae. The tomatoes are respiration climacteric vegetables, have respiratory peaks and ethylene release peaks, and are easy for ripening and senescence.

Kidney beans, a general term of all kinds of leguminous plant fruit, including pea beans, soybeans, cowpeas, etc. These fruits and vegetables are common vegetables in daily life, extensive nutritional resources, and widely popular.

Eggplants, one kind of few purple vegetables, and very common homemade vegetables at the dinner table. The eggplants are called Luo Su by Jiangsu people, are called Ai Gua by Guangdong and Guangxi people, and are Solanaceae, Solanum and annual herbs.

Sweet peppers, scientific name Capsicum annuum var. grossum, commonly known as bellpeppers, bell peppers, one variant of solanaceae capsicum peppers, distributed across the north and south of the Chinese mainland, nutritious, and suitable for consumption.

At present, the research on vegetable mixing storage modified atmosphere packaging is less, and multispecies mixing storage has certain problems: (1) after being picked, vegetables and fruits will produce a certain amount of ethylene (ripener), especially mixing storage of many kinds of vegetables and fruits will greatly shorten the storage tolerance period and the shelf life of the vegetables and fruits; (2) it easily leads to cross infection of germs, making vegetables and fruits extremely apt to rot; and (3) because places of origin, varieties, growth environmental conditions, cultivation management conditions of the vegetables and fruits are different, temperatures and humidity required for fresh storage thereof also vary, and storage periods of some kinds of vegetables and fruits will be affected during mixing storage.

Controlled Atmosphere Storage (CAS) is a fresh-keeping technology of controlling proportions of gases in a packaging container (good sealing) and real-time monitoring the proportions, can significantly reduce respiration intensity of vegetables, delays Vc, sugar and acid content and chlorophyll degradation and the like, and can inhibit microbe development, so as to effectively extend the storage period of the vegetables. Such a storage manner is applicable to storage and transportation of plenty of vegetables, especially marine transport. To obtain a stable gas component, guaranteeing airtightness of the packaging container is a primary condition. Secondly, three main factors affecting CA are controlled, which are respectively temperature, relative humidity and gas component. The temperature is vital for controlled atmosphere storage and is the basic condition of the storage, and a too high temperature will accelerate respiration of vegetables, thus accelerating the senescence; a too low temperature will lead to the phenomenon of chilling injury, and is not conducive to the storage. In addition, temperature fluctuations will also be harmful to the storage, mainly manifested as: stimulate strengthening of respiration of vegetables; accelerate the transpiration; easy to make “condensation” formed on vegetable surfaces, and create conditions for mould to breed and vegetables to rot.

1-MCP (1-methylcyclopropene) is an ethylene inhibitor, which can hinder ethylene from binding to its receptor, thus inhibiting the effect of ethylene. 6-benzyl aminopurine (6-BA) is a cytokinin compound in plant growth regulators, can promote biosynthesis of δ-aminolevulinic acid, inhibits protein degradation related to chlorophyll degradation, andδhas effects of keeping vegetables fresh and green and delaying leaf senescence.

Studies have shown that inert gas argon (Ar) has effects of inhibiting microbial growth and quality preservation. At the same time, there are reports showing that nitrogen (N2), and the inert gas such as argon (Ar) also could play a positive role in biochemistry, compete with oxygen molecule for binding sites of enzymes, thus inhibiting browning of fruits and vegetables and activity of some important enzymes in respiratory metabolism, such as tyrosinase and malate dehydrogenase, and have positive significance in preservation and freshness of the fruits and vegetables.

Xie Jing et al. (2012) disclosed a method for modified atmosphere packaging of leaf vegetable (Patent Application No.: 201210275931.3), after picking and selection, Chinese little greens were precooled to 2-4° C., and a four-gas mixture (CO₂, O₂, O₃, N₂) was used for modified atmosphere packaging, where the proportion of CO₂ was 5-15%, the proportion of O₂ was 1-15%, the proportion of O₃ was 1-5%, and the proportion of N₂ was 65-93%. Finally, the Chinese little greens after modified atmosphere packaging were placed in a constant temperature and humidity chamber where the temperature was 2-6° C. and humidity was 70-80% for cold storage, which can make the storage period of the Chinese little greens extended from 2-3 days at room temperature to more than 20 days. The invention is different from the present invention in that: the invention uses four gases for modified atmosphere packaging and is storage of single vegetable variety, while the present invention uses a different gas, i.e., Ar, for controlled atmosphere and carries out hybrid storage for three kinds of fruits and vegetables, along with treatment of 1-MCP or the like.

Wang Libin et al. (2013) studied influences of controlled atmosphere storage on physiological and biochemical characteristics of kidney beans, the results showed that the gas composition of 5%O₂+1%CO₂+94%N₂ and temperature of 9.0±0.5° C. was conductive to maintaining the quality of the storage period of the kidney beans, and the storage time thereof was prolonged.

M.C. Sanchez-Mata et al. (2003) studied influences on extension of the storage period and maintenance of nutrition of the kidney beans, nutrition indexes mainly including vitamin and mineral content. Four groups of tests were designed: normal atmosphere, 5%O₂+3%CO₂, 3%O₂+3%CO₂ and 1%O₂+3%CO₂. They were all stored in an environment of 8° C., and the results showed that the gas component of 3%O₂+3%CO₂ had the best effects on prolonging the storage period and maintenance of nutrition of the kidney beans.

çaĝatay Özden et al. (2002) studied influences of the CA in combination with edible film coating on the storage period and the quality of the green pepper by using the green pepper as the experimental material, cold storage in combination with the coating can effectively keep Vc and chlorophyll content of the green pepper, but under the CA condition, the quality of the green pepper cannot be kept well. Ioannis S. Arvanitoyannis et al. (2005) studied influences of the CAS on the quality during storage of eggplants, and for the eggplants stored in the CAS, the Vc retention rate was higher, the hardness was better, and the overall sensory quality was better.

Che Qianli et al. (2004) disclosed a method for controlled atmosphere storage and fresh-keeping of snap beans (Patent Application No. 03111242.0), snap beans were used as the raw material, the air-conditioned cold store was disinfected and precooled, the controlling temperature was 7.5-9° C., the proportion of O₂ was 6-8%, the proportion of CO₂ was 1-2%, and relative humidity was 90-95%. The snap beans stored with the method prolonged the storage period and the shelf life, which can be up to 90 days. After the delivery, the shelf life was extended from ordinary refrigeration of 3-4 days to 7-10 days.

The inventions and research mainly focused on studying controlled atmosphere storage of a single variety, according to the results of the research, modified atmosphere packaging had good effects for preservation of a single variety, but the inventions and research did not relate to the study of multispecies hybrid storage and using an ethylene inhibitor (such as 1-MCP) for treatment; the present invention discusses the modified atmosphere packaging technology of mixing storage of many kinds of fruits and vegetables, and selects the typical climacteric fruits and vegetables for experimental studies, along with 1-MCP or 6-BA treatment, which has good effects and can make the preservation time of mixing storage of many kinds of fruits and vegetables more than 50 days.

Kwang Soo Lee et al. (1996) studied modified atmosphere packaging of mixed vegetable salad, fresh-cut carrots, fresh-cut cucumber, garlic slices and green peppers were used as materials, and, according to respiration data of each component in combination with permeability of the packaging film, the appropriate packaging atmosphere was predicted to the purpose of extending the shelf life. Suitable packing conditions should tolerate the lowest O₂ concentration, the highest CO₂ concentration and the temperature of chilling injury. Experimental results showed that 27-micron-thick low-density polyethylene bags can form a gas component of which the proportion of O₂ was 2.0-2.1% and the proportion of CO₂ was 5.5-5.7%, and the component was conductive to maintenance of the quality of all the components of vegetables. The research studied the modified atmosphere packaging of mixed vegetable salad, but the raw material was not intact vegetables but fresh-cut vegetables, the characteristics were different from the intact ones.

Giovanna O. Scifòet al. (2008) mainly studied the growth of Listeria innocua during mixing storage of fresh-cut leaf vegetables, the results showed that breeding of Listeria innocua can be supported if the initial gas concentration was 6%CO₂+3%O₂, and the results showed that the modified atmosphere packaging should be combined with other fresh-keeping technologies to inhibit the breeding of pathogenic microorganisms in the fresh-cut vegetables.

The research mainly studied mixing storage of fresh-cut vegetables, but did not relate to the research on mixing storage of intact vegetables, and did not use auxiliary treatment; the present invention studied mixing storage of many kinds of intact fruits and vegetables, supplemented by 1-MCP treatment, and could achieve good effects.

At present, successful examples of applications of modified atmosphere packaging of vegetables are more, but most of the research focuses on storage of a single variety, there is little research on vegetable mixing preservation and freshness technologies, reference data is less, and further research and exploration are needed. In terms of marine preservation, Generally, it is less than 1 month or up to 100 days at sea, because the ocean ship has limited space and is far from land, sufficient supplies (including vegetables) should be carried at a time. Whether the crew can eat fresh and rich vegetables is important guarantee for the successful completion of the task. Shipping business is developing rapidly at present, carrying and transporting goods on ships is particularly important, how to make full use of the limited space on board and increase the diversity of the stored vegetables is of great significance. Traditional modified atmosphere packaging is mostly used in preservation of a single variety of fruits and vegetables, and fewer varieties of vegetables can be stored in the limited space.

### SUMMARY

An objective of the present invention is to overcome the deficiencies and provide a modified atmosphere packaging technology of fruit and vegetable mixing storage, which relates to mixed vegetable fresh-keeping technologies and broadens the application field of the modified atmosphere packaging technology.

The technical solution of the present invention is a control method for mixing controlled atmosphere storage of fruit vegetables on oceangoing ships, including steps of:

(1) preparing an air-conditioned cold store: cleaning, sterilizing and disinfecting an air-conditioned cold store where fruit vegetables are to be stored;

(2) selecting fruits and vegetables: selecting many kinds of fruits and vegetables picked; and picking up fruits and vegetables which are uniformly sized, have similar ripeness, are in normal color and fresh, and have no obvious defects;

(3) precooling: rapidly putting the fruits and vegetables selected in step (2) into a vacuum pre-cooler to be precooled to 9-11° C., the precooling time being 12-24 h, along with 1-MCR fumigation or 6-BA treatment; and

(4) stacking: rapidly stacking the fruits and vegetables precooled in step (3) into the air-conditioned cold store, setting the air-conditioned cold store, and then the device operating for storage.

The fruits and vegetables which have no obvious defects in step (2) are fruits and vegetables which do not contain yellow leaves, have no mechanical damage, no mildew and rot, no freezing injury and no plant diseases and insect pests.

During the 1-MCR fumigation treatment in step (3), fumigation concentration is 1.0 μL/L; and during the 6-BA treatment, the fruits and vegetables are soaked for 3 min by using 50 mg/L of 6-BA.

When the air-conditioned cold store is set in step (4), controlled atmosphere in the early stage is as follows: the proportion of O₂ is 5%, the proportion of CO₂ is 4%, the proportion of N₂ is 90%, the proportion of Ar is 1%, relative humidity is 85%, and the temperature is set as 10±1° C.; and

20 days later, the controlled atmosphere is changed as follows: the proportion of O₂ is 3%, the proportion of CO₂ is 3%, the proportion of N₂ is 93%, the proportion of Ar is 1%, relative humidity is 90%, and the temperature is set as 9±1° C.

An air humidification system adopts a nano water atomization technology to maintain stable humidity, particle sizes of nano droplets are 10-100 nm, and the stable humidity is very important for keeping freshness of fruits and vegetables.

Because the storage temperature of fruits and vegetables is higher, vegetables respire strongly, it is easy to reach respiration peak, and through the adoption of ethylene inhibitor (1-MCP or 6-BA) for treatment, ethylene release of climacteric vegetables can be effectively inhibited, thus inhibiting the respiration action thereof.

When a two-stage modified atmosphere packaging technology is used, early and later stages of modified atmosphere packaging adopt different gas component proportions, vegetables have different characteristics such as respiration in early and later stages of the storage, suitable gas component proportions are different, in the early stage, because vegetables respire strongly, with reference to the tolerance range of O₂ and CO₂ of each kind of fruits and vegetables, the gas component in the early stage is set as 5%O₂+4%CO₂+90%N₂+1%Ar, the relative humidity is 85%, and the temperature is set as 10±1° C.; the gas component in the later stage is set as 3%O₂+3%CO₂+93%N₂+1%Ar, the relative humidity is adjusted as 90%, and the temperature is set as 9±1° C. The early and later stages can be divided according to the storage period of 20 days. Use of the two-stage modified atmosphere packaging technology is closer to the characteristics of vegetables than the one-stage modified atmosphere packaging, and the effect is more significant.

The ozone sterilization technology, because of the higher fruit and vegetable storage temperature and the higher humidity in the present invention, easily causes the breeding of mould and other microbes, and using an ozone generator for conventional secondary sterilization of the air-conditioned cold store can achieve synergistic antimicrobial effects.

The present invention has the following beneficial effects: compared with the traditional fresh-keeping technologies, the present invention uses a fruit and vegetable mixing modified atmosphere packaging technology, improves variety of vegetables to some extent, and also expands the application field of the modified atmosphere packaging technology in vegetable preservation.

The present invention can extend the storage period of mixing storage of many kinds of typical fruits and vegetables to more than 50 days, during which the fruits and vegetables are still in good color and flavor, and have higher peroxidase (POD), superoxide dismutase (SOD), catalase (CAT) and cellulose (CE) activity; at the same time, accumulation of hazardous substances such as superoxide anion free radical (O₂⁻·), hydrogen peroxide (H₂O₂) and malonaldehyde (MDA) is effectively reduced, the retention rate of Vc is up to 80%-90%, and the weight loss ratio can be controlled to be below 8%. The present invention can enrich varieties of controlled atmosphere storage, improve space utilization, and have a great deal of practical popularization sense especially for the oceangoing ship industry.

### DETAILED DESCRIPTION

### EXAMPLE 1

### Method for mixing controlled atmosphere storage of three kinds of typical fruit-vegetable (tomatoes, green peppers and kidney beans) vegetables supplemented by 6-BA

Conventional cleaning, sterilization and disinfection were carried out on an air-conditioned cold store. Three kinds of fruits and vegetables were picked, which were uniformly sized, had similar ripeness, were in normal color and fresh, and had no obvious defects (including yellow leaves, mechanical damage, mildew and rot, freezing injury, and plant diseases and insect pests). The three kinds of fruits and vegetables picked up were rapidly put in a vacuum precooling device for precooling, the time was 12 h, after the temperature was reduced to 10° C., precooling was stopped, the fruits and vegetables were socked and treated with 6-BA, the concentration is 50 mg/L, and the time was 3 min. Then, the precooled fruits and vegetables were respectively put in a box 50 cm long and 40 cm wide, neatly stacked and not squeezed, and each basket of vegetables weighs about 8 kg. The controlled atmosphere parameters of the air-conditioned cold store were set, the temperature was 10° C., and the relative humidity was 90%. The controlled atmosphere in the early stage was set as follows: the proportion of O₂ was 5%, the proportion of CO₂ was 4%, the proportion of N₂ was 90%, the proportion of Ar was 1%, relative humidity was 85%, and the temperature was set as 10±1° C.; and 20 days later, the controlled atmosphere was changed as follows: the proportion of O₂ was 3%, the proportion of CO₂ was 3%, the proportion of N₂ was 93%, the proportion of Ar was 1%, relative humidity was 90%, and the temperature was set as 9±1° C.

The storage periods of the three kinds of fruits and vegetables were all more than 50 days, during which the fruits and vegetables were still in good color and flavor, and had higher peroxidase (POD), superoxide dismutase (SOD), catalase (CAT) and cellulose (CE) activity; at the same time, accumulation of hazardous substances such as superoxide anion free radical (O₂⁻·), hydrogen peroxide (H₂O₂) and malonaldehyde (MDA) was effectively reduced, the retention rate of Vc was up to 80%-90%, and the weight loss ratio can be controlled to be below 8%. The method has great value of practical application.

### EXAMPLE 2

### Method for mixing controlled atmosphere storage of five kinds of typical fruit-vegetable (tomatoes, green peppers, kidney beans, sweet peppers and eggplants) vegetables supplemented by 1-MCP

Cleaning, sterilization and disinfection were carried out on an air-conditioned cold store. Five kinds of fruits and vegetables were picked, which were uniformly sized, had similar ripeness, were in normal color and fresh, and had no obvious defects (including yellow leaves, mechanical damage, mildew and rot, freezing injury, and plant diseases and insect pests). The five kinds of fruits and vegetables picked up were rapidly put in a vacuum precooling device for precooling, along with 1-MCP fumigation, the fumigation concentration was 1.0 μL/L, the time was 12 h, and after the temperature was reduced to 10° C., precooling was stopped. Then, the precooled fruits and vegetables were respectively put in a box 50 cm long and 40 cm wide, neatly stacked and not squeezed, and each basket of vegetables weighs about 8 kg. The controlled atmosphere in the early stage was set as follows: the proportion of O₂ was 5%, the proportion of CO₂ was 4%, the proportion of N₂ was 90%, the proportion of Ar was 1%, relative humidity was 85%, and the temperature was set as 10±1° C.; and 20 days later, the controlled atmosphere was changed as follows: the proportion of O₂ was 3%, the proportion of CO₂ was 3%, the proportion of N₂ was 93%, the proportion of Ar was 1%, relative humidity was 90%, and the temperature was set as 9±1° C.

The storage periods of the five kinds of fruits and vegetables were all more than 50 days, during which the fruits and vegetables were still in good color and flavor, and had higher peroxidase (POD), superoxide dismutase (SOD), catalase (CAT) and cellulose (CE) activity; at the same time, accumulation of hazardous substances such as superoxide anion free radical (O₂⁻·), hydrogen peroxide (H₂O₂) and malonaldehyde (MDA) was effectively reduced, the retention rate of Vc was up to 80%-90%, and the weight loss ratio can be controlled to be below 8%. The method has great value of practical application.

What is claimed is:

1. A control method for mixing controlled atmosphere storage of fruit vegetables on oceangoing ships, comprising:
(1) preparing an air-conditioned cold store: cleaning, sterilizing and disinfecting an air-conditioned cold store where fruit vegetables are to be stored;
(2) selecting fruits and vegetables: selecting many kinds of fruits and vegetables picked; and picking up fruits and vegetables which are uniformly sized, have similar ripeness, are in normal color and fresh, and have no obvious defects;
(3) precooling: rapidly putting the fruits and vegetables selected in step (2) into a vacuum pre-cooler to be precooled to 9-11° C., the precooling time being 12-24 hours, along with 1-MCR fumigation or 6-BA treatment; and
(4) stacking: rapidly stacking the fruits and vegetables precooled in step (3) into the air-conditioned cold store, setting the air-conditioned cold store, and then the device operating for storage.

2. The control method for mixing controlled atmosphere storage of fruit vegetables on oceangoing ships according to claim 1, wherein the fruits and vegetables which have no obvious defects in step (2) are fruits and vegetables which do not contain yellow leaves, have no mechanical damage, no mildew and rot, no freezing injury and no plant diseases and insect pests.

3. The control method for mixing controlled atmosphere storage of fruit vegetables on oceangoing ships according to claim 1, wherein, during the 1-MCR fumigation treatment in step (3), fumigation concentration is 1.0 μL/L; and during the 6-BA treatment, the fruits and vegetables are soaked for 3 min by using 50 mg/L of 6-BA.

4. The control method for mixing controlled atmosphere storage of fruit vegetables on oceangoing ships according to claim 1, wherein, when the air-conditioned cold store is set in step (4), controlled atmosphere in the early stage is as follows: the proportion of O₂ is 5%, the proportion of CO₂ is 4%, the proportion of N₂ is 90%, the proportion of Ar is 1%, relative humidity is 85%, and the temperature is set as 10±1° C.; and
20 days later, the controlled atmosphere is changed as follows: the proportion of O₂ is 3%, the proportion of CO₂ is 3%, the proportion of N₂ is 93%, the proportion of Ar is 1%, relative humidity is 90%, and the temperature is set as 9±1° C.
